(19) United States
(12) Patent Application Publication
(10) Pub. No.: US 2013/0247113 A1
(43) Pub. Date: Sep. 19, 2013

(54) MULTI-IMAGE SWITCHING METHOD AND SYSTEM

(71) Applicant: MSTAR SEMICONDUCTOR, INC., Hsinchu County (TW)

(72) Inventors: Ren-Zhen Zheng, Hsinchu County (TW); Jian-Qun Jiang, Hsinchu County (TW); Xiang Ye, Hsinchu County (TW)

(73) Assignee: MStar Semiconductor, Inc., Hsinchu County (TW)

(21) Appl. No.: 13/804,292

(22) Filed: Mar. 14, 2013

(30) Foreign Application Priority Data
Mar. 15, 2012 (CN) 201210069040.2

(51) Int. Cl. H04N 21/41

(52) U.S. Cl. CPC H04N 21/4126
USPC 725/61

(57) ABSTRACT

A multi-image switching method is provided. The switching method includes steps of: establishing a connection between a portable device and a smart device, and fetching a program source list from the smart device; transmitting a watch request message to the smart device according to a user-selected program source from the program source list, wherein the watch request message includes program source identification information; and receiving program information, which is corresponding to the program source identification information and replied by the smart device in response to the watch request message, and providing the program information to the portable device for display. Therefore, according to the embodiments, the same or different program information may be simultaneously viewed on the portable device and the smart device after establishing the connection between the portable device and the smart device through a handshake protocol.

This application claims the benefit of People's Republic of China application Serial No. 201210069040.2, filed Mar. 15, 2012, the disclosure of which is incorporated by reference herein in its entirety.

### BACKGROUND

1. Technical Field

The disclosed embodiments relate to a multimedia communication and control field in general, and more particularly to a multi-image switching method and system.

2. Description of the Related Art

With the prevalence of smart devices and the accompanied emergence of smart televisions, smart set-up boxes and Internet televisions, diversified contents and applications of wired television signals and Internet media information have gradually infused into household digital media activities.

Through integration of communication networks, broadcasting television networks, the Internet and multi-screen systems, a same program may be simultaneously viewed on a smart device and a portable device to realize synchronous view of a remote television and multimedia information. However, such single-task and single-application restrictions of a smart device are becoming inadequate in satisfying application requirements of modern household entertainment and daily activities.

### SUMMARY

The disclosure is directed to a multi-image switching method and system for allowing simultaneous viewing of the same or different program information on a portable device and a smart device after establishing a connection based on a handshake protocol between the portable device and the smart device.

According to one embodiment, a multi-image switching method is provided. The method comprises steps of: establishing a connection between a portable device and a smart device and fetching a program source list from the smart device; transmitting a watch request message to the smart device according to a user-selected program source from the program source list, wherein the watch request message includes program source identification information; receiving program information, which is corresponding to the program source identification information and replied by the smart device in response to the watch request message; and providing the program information to the portable device for display.

In one embodiment, after establishing the connection between the portable device and the smart device, a request message for fetching the program source list is transmitted to the smart device.

In one embodiment, the step of establishing the connection between the portable device and the smart device comprises steps of: the portable device transmitting a handshake request message through broadcasting; monitoring a broadcasting port to receive a handshake acknowledgement message replied by the smart device; and transmitting a handshake success message to the smart device.

According to another embodiment, a multi-image switching method for a smart device is provided. The method comprises steps of: receiving and decoding multiple program sources to generate at least one set of program information and a program source list; establishing a connection with a portable device, sending the program source list to the portable device; receiving a watch request message transmitted from the portable device, wherein the watch request message includes program source identification information; fetching program information corresponding to the program source identification information; and transmitting the program information to the portable device for display.

In one embodiment, after establishing the connection between the portable device and the smart device, a request message for fetching the program source list is transmitted to the smart device.

According to an alternative embodiment, a multi-image switching system is provided. The system comprises: a smart device, for receiving and decoding multiple program sources to output at least one set of program information, and accordingly generating and transmitting a program source list; and a portable device, signally connected to the smart device, for receiving and fetching the program source list, and transmitting a watch request message including program source identification information according to a user-selected program source from the program source list. After receiving the watch request message, the smart device fetches and transmits program information corresponding to the program source identification information to the portable device. The portable device receives and displays the program information.

In one embodiment, the multi-image switching system comprises at least one portable device.

The portable device comprises: a first fetching module, for fetching the program source list; a first transmission module, for transmitting the watch request message according to the user-selected program source from the program list to the smart device; and a first reception module, for receiving the program information, which is corresponding to the program source identification information and replied by the smart device in response to the watch request message, and displaying the program information.

In one embodiment, the portable device further comprises a second transmission module for transmitting a request message for fetching the program source list to the smart device.

In one embodiment, the smart device further comprises a first handshake module for establishing a connection between the portable device and the smart device. The first handshake module comprises: a first transmission unit, for transmitting a handshake request message; a reception unit, for monitoring a broadcasting port, and accordingly receiving a handshake acknowledgement message replied by the smart device; and a second transmission unit, for transmitting a handshake success message to the smart device after the reception unit receives the handshake acknowledgement message replied by the smart device.

The smart device comprises a multi-image switching unit. The multi-image switching unit comprises: a generation module, for decoding multiple received program sources to output at least one set of program information and to generate the program source list; a third transmission module, for transmitting the program source list to the portable device after establishing the connection with the portable device; a second reception module, for receiving the watch request message; and a fourth transmission module, for fetching and transmitting the program information corresponding to the program source identification information from the portable device.

In one embodiment, the third transmission module initiatively transmits the program source list to the portable device, and the program source list can be updated in real-time.

According to the embodiments, a handshake and connection is first established between a smart device and a portable device. The portable device fetches a program source list transmitted from the smart device through the connection after the handshake, and implements independent switching of a program source on the portable device according to the program source selected from the program source list. Furthermore, the portable device transmits a watch request message to the smart device according to the selected program source, receives program information, which is corresponding to the user-selected program source and replied by the smart device, and displays and outputs the program information.

Therefore, according to the embodiments, the same or different program information may be simultaneously viewed on the portable device and the smart device after establishing the connection between the portable device and the smart device through a handshake protocol. Whereas in a conventional situation, only the same program can be simultaneously viewed on a smart device and a portable device

### BRIEF DESCRIPTION OF THE DRAWINGS

FIG. 1 is a first flowchart of a multi-image switching method according to one embodiment.

FIG. 2 is a second flowchart of a multi-image switching method according to one embodiment.

FIG. 3 is a flowchart of a multi-image switching method according to another embodiment.

FIG. 4 is a schematic diagram of a process performed by a multi-image switching system according to one embodiment.

FIG. 5 is a schematic diagram of a portable device in a multi-image switching system according to one embodiment.

FIG. 6 is a schematic diagram of a multi-switching unit according to one embodiment.

FIG. 7 is a schematic diagram of a smart device in a multi-image switching system according to one embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Different embodiments shall be given below with the accompanying drawings.

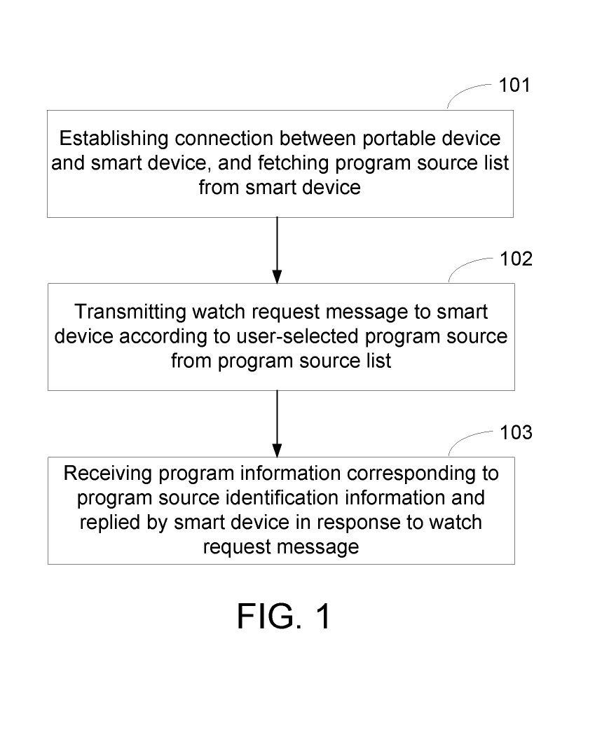

FIG. 1 shows a flowchart of a multi-image switching method according to one embodiment.

Referring to FIG. 1, the multi-image switching method includes the following steps. In step 101, a connection between a portable device and a smart device is established, and a program source list is fetched from the smart device. In step 102, according to a user-selected program source from the program source list, a watch request message is sent to the smart device. The watch request message includes program source identification information. In step 103, program information, which is corresponding to the program source identification information and replied by the smart device in response to the watch request message, is received, and the program information is provided to the portable device for display. Details of the three steps above will be further discussed below.

In step 101, the connection between the portable device and the smart device is established, and the program source list is fetched from the smart device. For example, the smart device is operable on a operating system including Android, iOS, Windows Mobile or Windows CE, and is capable of downloading and installing software and services as well as supporting wired or wireless Internet access interfaces. For example, the smart device is a smart digital television, a computer or a smart set-up box.

For example, the portable device is operable on a operating system including Android, iOS, Windows Mobile or Windows CE, and is capable of downloading and installing software and services as well as supporting wired or wireless Internet access interfaces. For example, the portable device is an Android or Apple smart handset or portable pad.

A transmission mode between the portable device and the smart device may be implemented by a wired or wireless transmission mode, such as Registered Jack 45 (RJ45), Recommended Standard 232 (RS232), WiFi, Bluetooth, Zigbee, infrared or 3^{rd} generation of mobile communications technology.

In order to implement the function of viewing multiple sets of program information between the smart device and the portable device, a connection needs to be first established between the two. That is, a handshake procedure is first performed between the two to notify each other of the mutual existence. Steps of the handshake procedure between the smart device and the portable device according to a preferred embodiment are described below.

In step (A), the portable device transmits a handshake request message through broadcasting. For example, a format of the handshake request message may be “HandshakeReq+ handheld apparatus identity”. The handheld apparatus identity may be a serial number, a barcode, a two-dimensional code, a MAC address or an IP address of the portable device. Furthermore, an instruction of the handshake request message may be generated through clicking, touching or swinging.

In step (B), the smart device monitors a broadcasting port, and receives the handshake request message transmitted from the portable device. After parsing the handshake request message, it is determined whether a request response is to be replied according to a permission control device of the smart device. When the operation is permitted, a handshake acknowledgement message “HandshakeAck+ handheld apparatus identity+ device code” is replied. The apparatus identity may be a serial number, a barcode, a two-dimensional code, a MAC address or an IP address of the smart device.

In step (C), the portable device monitors the broadcasting port, receives the handshake acknowledgement message replied by the smart device, parses the handshake acknowledgement message to form a list of all smart devices allowed for establishing a handshake relationship, and displays the list.

In step (D), the portable device selects a terminal on the smart device list according to a user selection instruction, and transmits a handshake success message “HandshakeOK+handheld apparatus+device code” to the selected smart device. After the selected smart device receives and confirms the handshake success message, the handshake procedure between the portable device is successfully performed and thus ends.

It should be noted that, the portable device may directly retrieve a smart device list of smart devices allowed for establishing the handshake relationship generated in a previous handshake procedure, and select a smart device on the smart device list, then directly transmit the handshake success message “HandshakeOK+handheld apparatus+device code” to the selected smart device to further complete the handshake procedure.

After the portable device transmits the handshake request message, given that only one smart device within coverage replies the handshake acknowledgement message, the portable device automatically transmits the handshake success message to complete the handshake procedure. As such, the handshake procedure is simplified as no manual selection of a user is required.

To prevent an apparatus signal interference, a password confirmation may be added into the handshake procedure. Alternatively, to prevent an information leak, information of the handshake procedure may be processed by encryption, which is RSA or Data Encryption Standard (DES), for example.

After establishing the handshake between the portable device and the smart device, an image switching operation between the portable device and the smart device can be implemented. However, to view the same or different programs on the portable device and the smart device, the steps below need to be further performed.

In step (A), the portable device transmits a program source fetching request message “ProgramListReq+handheld apparatus identity+device code” to the smart device.

In step (B), the smart device receives the program source fetching request message, and replies a program source list message “ProgramLisRsp+handheld apparatus identity+device code”.

The smart device receives one or multiple program sources via a program source channel, decodes the program source(s), and outputs the decoded program source(s). The smart device may then select a desired program by switching the program source(s) via an operation interface.

For example, the multiple program sources of the smart device may be a multi-channel multi-source or a single-channel multiplexed multi-source, and are inputted through a multi-channel multi-source access or a single-channel multiplexed multi-source access. For example, the multi-channel multi-source may be a network program source having either wired or wireless channels and a television program source having television channels; the single-channel multiplexed multi-source may be a television program source or a DVD program source having only television channels.

For example, the channels include television channels, wired or wireless networks, infrared and Bluetooth. Furthermore, the television channels refer to television connectors including TV, High-Definition Multimedia Interface (HDMI), Video Graphics Array (VGA), (Digital Video Input) and Universal Serial Bus (USB).

The program channels and program sources of the smart device include wired or wireless television program sources, network program sources, DVD, AV, USB or other program sources inputted by other connection equipments.

The operation interface of the smart device may be an equipment operation panel, a remote controller, or a handheld apparatus remote control system. The approach for switching the program sources of the smart device may be through a remote controller or a handset PAD instruction.

The smart device may receive and play one or multiple sets of program information, and the source of the program information may be wired television signals or network media information.

It should be noted that, the portable device may periodically transmit a program source list update request.

After the successful handshake procedure, the smart device may automatically transmit a program source list notification message.

After the successful handshake procedure, each time a program source is updated, the smart device automatically transmits the program source list update message “ProgramLisRefush+handheld apparatus identity+device code+DEL: program source 1+ADD: program source 2 . . . ”, wherein “DEL: program source 1” represents program source to be deleted, and “ADD: program source 2” represents a program source to be added. Both of the program source to be deleted and the program source to be added may exist at the same time.

In step 102, referring to FIG. 1 and paragraph [0029], the view request information is sent to the smart device according to the user-selected program source from the program source list. The watch request message includes program source identification information.

Once the portable device receives the program source, the program source list is generated for the user to select from. The user may select one or multiple program sources.

A method for selecting the program resource includes pressing a button, audio identification and handset PAD gravitation operations.

After one or multiple program sources are selected by the user, a watch request message “ProgramViewReq+handheld apparatus identity+device code+ADDVIEW: program source 1+ADDVIEW: program source 2+DELVIEW: program source 3+DELVIEW: program source 4+ . . . ” is transmitted to the smart device, wherein “DELVIEW: program source 1” represents a program source that is no longer desired, and “ADDVIEW: program source 2” represents a newly desired program source to be viewed. Furthermore, the smart device may provide either or both of the no-longer-desired program source and the newly-desired program source.

In step 103, the program information, which is corresponding to the program source identification information and replied by the smart device in response to the watch request message, is received, and the program information is sent to the portable device for display.

After receiving the watch request message, the smart device decodes and recompresses the program information of the designated program source, and transmits the decoded and recompressed program information to the portable device via a transmission channel.

A method for transmitting the program information includes WiFi, Bluetooth, infrared or wired connections. A method for processing the program information includes compression and encoding.

The portable device receives and decodes the program information, and displays and outputs the decoded program information. After viewing of the program information ends, the handshake is canceled.

Under considerations of reducing the amount of data and distortion, lossy compression or lossless compression may be adopted as the compression encoding algorithm.

It should be noted that, after establishing the handshake between the smart device and the portable device, the portable device may also directly receive the program information through a wired or wireless channel without performing program source switching, and displays and outputs the decoded program information.

The portable device may switch the program source before viewing the program or when viewing the program.

Based on the smart device and the portable device of the embodiments, multiple program sources inputted into the smart device are decoded by a multipath decoder of the smart device. Thus, at the same time when outputting one or multiple sets of program information on a display screen and a speaker of the smart device, the same or different one or multiple sets of program information can be played on the smart device. After encoding the program information, the encoded program information is transmitted to the portable device via a wired or wireless transmission channel to the portable device. The portable device decodes the encoded program information, and displays and outputs the decoded program information through the display screen and the speaker.

With the above embodiments, a multi-image switching function between a smart device and a portable device is implemented. Through the image switching of the portable device, expansion of multitasking and multi-application household digital media life can be realized using a single smart device, so that different or the same program information can be simultaneously viewed on the portable device and the smart device. Furthermore, either of the two devices is capable of independently switching program sources to enrich applications of the smart device while offering more convenient and resource-economized operations.

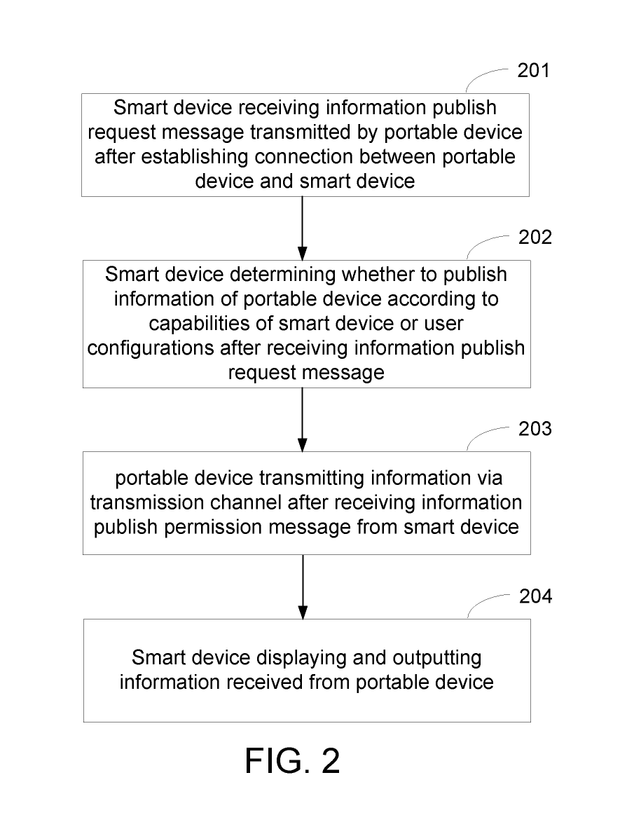

The embodiment in FIG. 1 further comprises a multi-image switch method shown in FIG. 2. Referring to FIG. 2, in addition to implementing image switching on a portable device, image switching may also be implemented on a smart device. That is to say, media file information stored at a local end or media streams collected in real-time by the portable device may be displayed and outputted by a smart device or outputted via an access channel of the smart device. More specifically, the process in FIG. 2 comprises the following steps.

In step 201, after establishing a connection between a portable device and a smart device, the smart device receives an information publish request message “PublishReq+MediaType+PublishMode” transmitted by the portable device, wherein “MediaType” represents a media type of information to be published, including non-real-time media files and real-time media streams, and “PublishMode” represents a mode of information to be published, including an output from a smart device display output and an output from a smart device access channel.

In step 202, the smart device receives the information publish request message, and determines whether to publish the information to the portable device. When the information publish request is granted, an information publish permission message is transmitted to the portable device.

The format of the information publish permission message is “PublishOK+MediaType+PublishMode”, wherein “MediaType” and “PublishMode” are the same as those in step 201.

In step 203, the information publish permission message is received by the portable device, and the information is transmitted via a transmission channel.

The information format is “PublishData+MediaType+PublishMode+MediaPt+TotalLen+CurrentLength+MediaData”, wherein “MediaPt” represents a media payload type (i.e., the media format), “TotalLen” represents a total length of the media and may be represented by “−1” for a media stream, “Current Length” represents a media length transmitted by the current message, and “MediaData” is the media data actually being transmitted. The media data represented by “MediaData” is compliant to a standardized real-time transport protocol (RTP) format or is constructed based on a self-defined format.

For example, the information may include images, audios, videos, documents stored at the local end, or audio and video information streams collected in real-time.

In step 204, the smart device receives the information transmitted from the portable device, and displays and outputs the information.

According to the above process, media file information, such as videos, audios, images and texts stored at the local end, and media stream information of the portable device collected in real-time, may be displayed and outputted by a smart device with a successful handshake or outputted via an access channel of a smart device in real-time or non-real-time, thereby implementing an application of publishing information of the portable device by the smart device.

In the processes in FIGS. 1 and 2, a common feature is that, after the smart device and the portable device complete the multi-image switching, the handshake may be canceled when image switch of a next program is no longer desired. For a program already played with the construction of the multi-image switching, viewing of the program can be continued on the smart device and the portable device given that the smart device and the portable device remain powered on.

To cancel the handshake, either of the smart device or the portable device may initiatively transmit a handshake cancel message “HandshakeCancel+handheld apparatus identity+device code” to the other, wherein “handheld apparatus identity” is the identity of the portable device, and “device code” is the identity of the smart device.

Either of the image switching modes depicted in FIGS. 1 and 2 may exist after the connection is established between the smart device and the portable device. Both of them may exist at the same time after the connection is established between the smart device and the portable device as well.

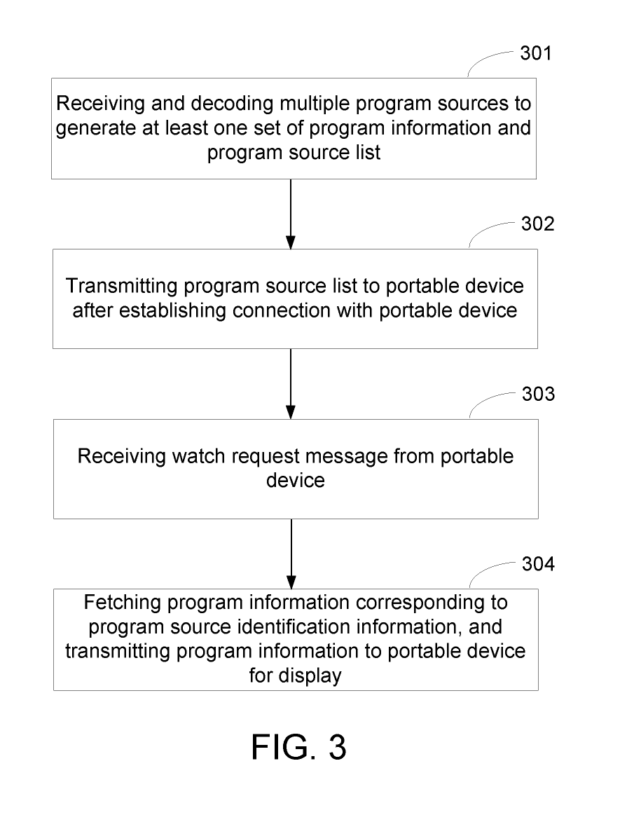

FIG. 3 shows a flowchart of a multi-image switching method according to another embodiment. The method in FIG. 3 comprises the following steps. In step 301, multiple program sources are received and decoded to generate at least one set of program information and a program source list. In step 302, a connection is established with a portable device, and the program source list is sent to the portable device. In step 303, a watch request message transmitted from the portable device is received, wherein the watch request message includes program source identification information. In step 304, program information corresponding to the program source identification information is fetched, and the program information is transmitted to the portable device for display. Details of the above steps are further discussed below.

In step 301, multiple program sources are received and decoded to output one or multiple sets of program information and to generate the program source list.

The smart device receives and decodes one or multiple program sources via a program source channel, and outputs the decoded program sources. The smart device may select a desired program by switching the program resources via an operation interface. Furthermore, the program source list is generated from the multiple program sources received.

For example, the multiple program sources of the smart device may be a multi-channel multi-source or a single-channel multiplexed multi-source, and are inputted through a multi-channel multi-source access or a single-channel multiplexed multi-source access.

For example, the channels include television channels, wired or wireless networks, infrared and Bluetooth.

The program channels and program sources of the smart device include wired or wireless television program sources, network program sources, DVD, AV, USB or other program sources inputted by other connection equipments.

The operation interface of the smart device may be an equipment operation panel, a remote controller, or a handheld apparatus remote control system. The approach for switching the program sources of the smart device may be through a remote controller or a handset PAD instruction.

The smart device may receive and play one or multiple sets of program information, and the source of the program information may be wired television signals or network media information.

In step 302, the connection is established with the portable device to transmit the program source list to the portable device.

Details of a handshake between the smart device and the portable device are the same as those described in the embodiment of FIG. 1, and shall be omitted herein.

For example, the smart device may transmit the program source list to the portable device by the three approaches below.

In the first approach, the portable device first transmits a program source list fetching request message to the smart device, and the smart device transmits the program source list back to the portable device after receiving the request.

In a second approach, after a successful handshake, the smart device automatically transmits a program source list notification message to the portable device.

In a third approach, after a successful handshake, each time a program source is updated, the smart device automatically transmits a program source list update message “ProgramLisRefush+handheld apparatus identity+device code+DEL: program source 1+ADD: program source 2 . . . ” to the portable device, wherein “DEL: program source 1” represents a program source to be deleted, and “ADD: program source 2” represents a program source to be added. Both of the program source to be deleted and the program source to be added may exist at the same time.

In step 303, the watch request message transmitted by the portable device is received. The watch request message includes program source identification information. After receiving the program sources, the portable device generates the program source list for the user to select from. The user may select one or multiple program sources, and transmit the watch request message to the smart device.

In step 304, the program information corresponding to the program source identification information is fetched, and is transmitted to the portable device for display. After receiving the watch request message, the smart device decodes and recompresses the program information corresponding to the designated program source, and transmits the decoded and recompressed program information to the portable device via a transmission channel. Thus, with the above process, switching of a program signal source for a portable device may be implemented.

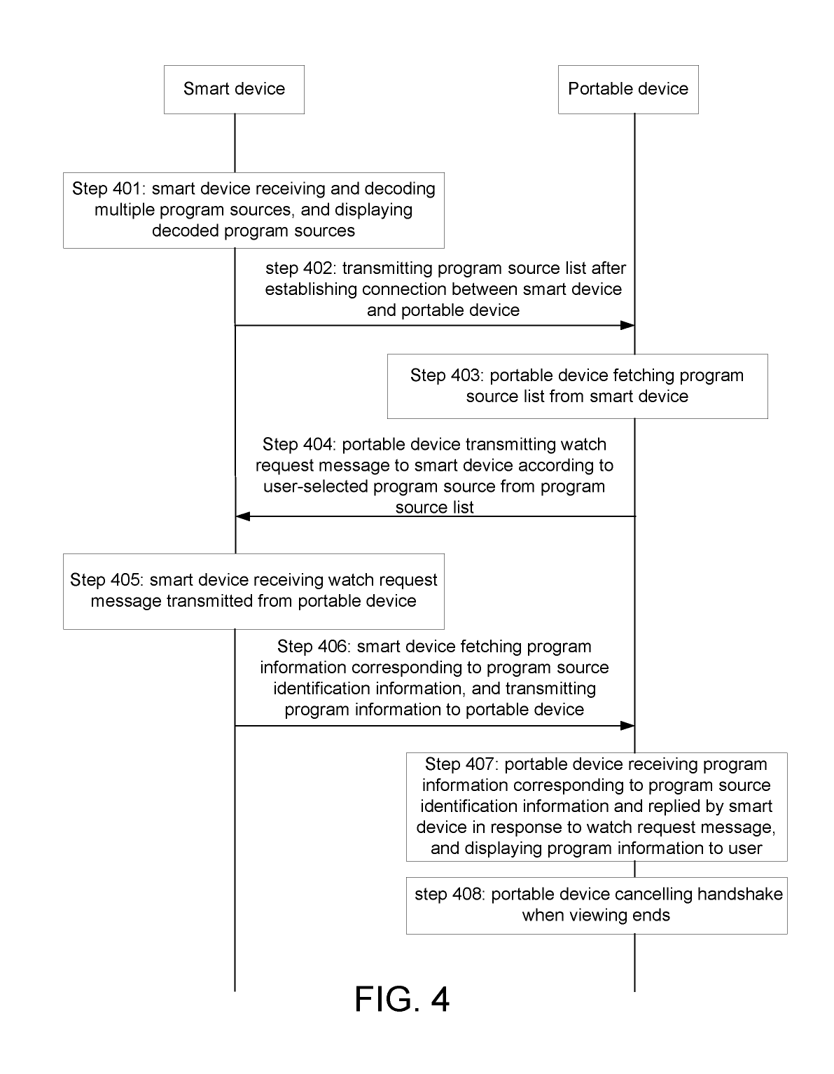

FIG. 4 shows a flowchart of a multi-image switching system according to one embodiment. As shown in FIG. 4, the multi-image switching system comprises a portable device and a smart device. Steps for implementing multi-image switching method by the multi-image switching system are as follows.

In step 401, the smart device receives and decodes multiple program sources, and displays the decoded program sources. The smart device may also switch the program sources via an operation interface.

In step S402, a connection is established between the smart device and the portable device, and a program source list is transmitted to the portable device. In the multi-image switching system, a handshake needs to be established in order to transmit data between the smart device and the portable device. The handshake process may take place before or after the smart device receives the program sources.

In step 403, the portable device fetches a program source list from the smart device.

In step 404, the portable device transmits a watch request message to the smart device according to a user-selected program source from the program source list. The watch request message includes program source identification information. Thus, the portable device may select a desired program source from the program source list to implement switching of the program source.

In step 405, the smart device receives the watch request message transmitted by the portable device. The watch request message includes program source identification information.

In step 406, the smart device fetches program information corresponding to the program source identification information, and transmits the program information to the portable device. That is, after receiving the watch request message, the smart device decodes and recompresses the program information of the designated program source, and transmits the decoded and recompressed program information to the portable device via a transmission channel.

In step 407, the portable device receives the program information, which is corresponding to the program source identification information and replied by the smart device in response to the watch request message, and displays the program information to the user. That is, the portable device receives and decodes the program information, and displays and outputs the decoded program information

In step 408, the portable device cancels the handshake after viewing of the program information ends.

In the multi-image switching system, the portable device displays and outputs media files information stored at a local end, or display and outputs media streams collected in real-time via the smart device, or outputs the same via an access channel of the smart device.

In the multi-image switching system, one or more than one portable device may be included.

In the multi-image switching system, one or more than one smart device may be included for implementing multi-image switching between the smart devices.

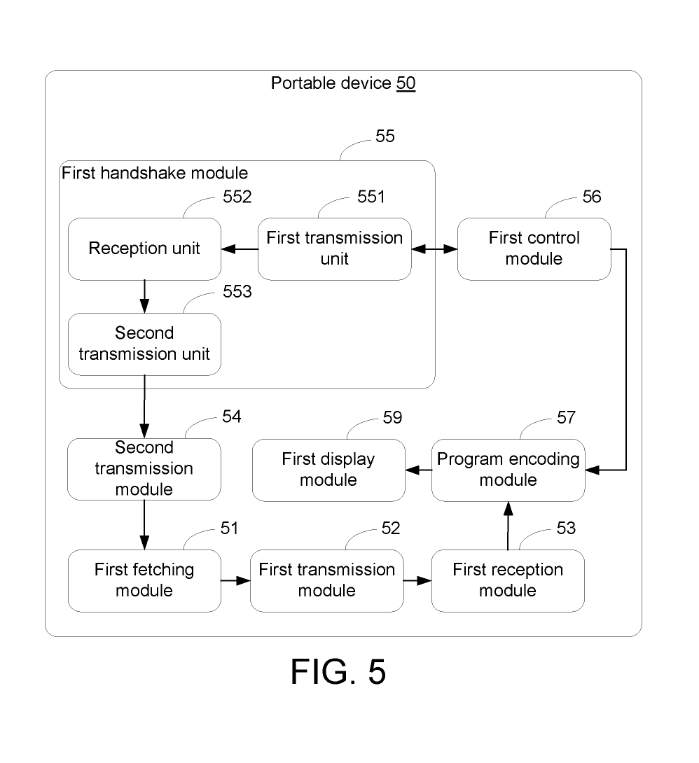

FIG. 5 shows a schematic diagram of a portable device in a multi-image switching system according to one embodiment. Referring to FIG. 5, a portable device 50 comprises a first fetching module 51, a first transmission module 52, a first reception module 53, a second transmission module 54, a first handshake module 55, a first control module 56, a program decoding module 57, a media encoding module 58 (not shown), and a first display module 59. The first handshake module 55 comprises a first transmission unit 551, a reception unit 552, and a second transmission unit 553.

The first fetching module 51 fetches a program source list from a smart device after a connection is established between the portable device 50 and the smart device.

The first transmission module 52 transmits a watch request message to the smart device according to a user-selected program source from the program source list. The watch request message includes program source identification information.

The first reception module 53 receives program information, which is corresponding to the program source identification information and replied by the smart device in response to the watch request message, and displays the program information.

The second transmission module 54 transmits a program source list fetching request message to the smart device.

Furthermore, in the first handshake module 55 for establishing the connection between the portable device 50 and the smart device, the first transmission unit 551 transmits a handshake request message, the reception unit 552 monitors a broadcasting port and receives a handshake acknowledgment message replied by the smart device, and the second transmission unit 553 transmits a handshake success message to the smart device after the reception unit 552 receives the handshake acknowledgement message replied by the smart device.

The first control module 56 controls the program decoding module 57 to decode and the media encoding module 58 to encode, and communicates with the first handshake module 55 to control the handshake procedure. The program decoding module 57 decodes the program information. The media encoding module 58 encodes media files stored at the portable device 50 or media streams collected in real-time from a media source. The first display module 59 displays and outputs the program information.

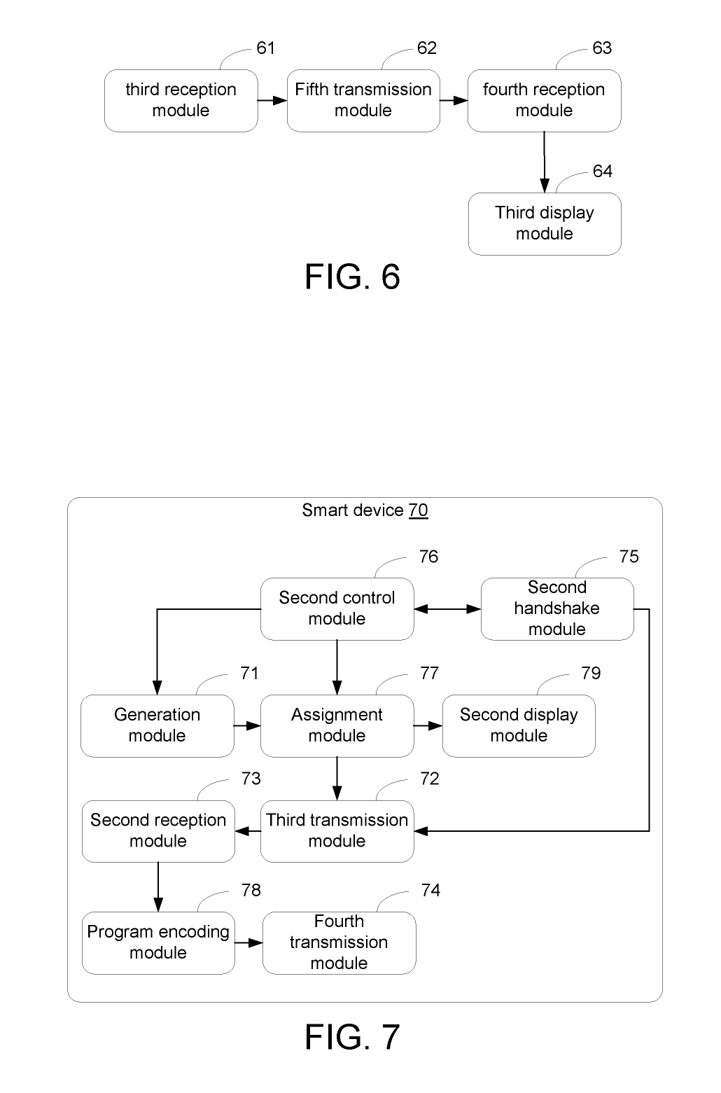

FIG. 6 shows a schematic diagram of a multi-image switching unit according to one embodiment. The multi-image switching unit, disposed in a smart device, for example, comprises a third reception module 61, a fifth transmission module 62, a fourth reception module 63 and a third display module 64.

The third reception module 61 receives an information publish request message sent by the portable device to the smart device after the connection is established between the portable device and the smart device.

After receiving the information publish request message, the smart device determines whether to publish information of the portable device using the fifth transmission module 62 according to capabilities of the smart device or user configurations. When the information publish request is granted, an information publish permission message is transmitted to the portable device.

After sending the information publish permission message to the portable device, the fourth reception module 63 transmits the information via a transmission channel.

The smart device then receives the information transmitted by the portable device, and displays and outputs the information using the third display module 64.

FIG. 7 shows a schematic diagram of a smart device in a multi-image switching system according to one embodiment. Referring to FIG. 7, a smart device 70 comprises a generation module 71, a third transmission module 72, a second reception module 73, a fourth transmission module 74, a second handshake module 75, a second control module 76, an assignment module 77, a program encoding module 78 and a second display module 79.

The generation module 71 decodes multiple program sources and outputs one or multiple sets of program information to generate a program source list.

The third transmission module 72 transmits the program source list generated by the generation module 71 after the connection is established between the portable device and the smart device. More specifically, the third transmission module 72 initiatively transmits the program source list to the portable device from the smart device. The program source list includes the program source list updated in real-time.

The second reception module 73 receives a watch request message transmitted by the portable device after the third transmission module 72 transmits the program source list to the portable device. The watch request message includes program source identification information.

The fourth transmission module 74 fetches program information corresponding to the program source identification information, and transmits the program information to the portable device.

The second handshake module 75 communicates with the portable device to establish a handshake.

The second control module 76 controls the generation module 71 to select a program source for decoding, and controls the assignment module 77 to assign the same program or different programs to different destinations.

The assignment module 77 assigns a particular set or particular sets of program information to a local display module 79 for display and output, and/or a particular set or particular sets of program information to be decoded by the program encoding module 78 and then transmitted to the portable device.

The program encoding module 78 encodes original program information to be assigned to the portable device.

The second display module displays and outputs the program information, and it may be a display screen, an external display device, a speaker or wireless earphones.

Referring to FIGS. 5, 6, and 7, an operation principle of multi-image switching between the smart device and the portable device is that, the smart device accesses multiple program sources via a wired or wireless transmission channel and inputs the program sources to the portable device, or publishes the media files stored at the portable device or media stream information collected in real-time from a media source, thereby implementing the multi-image switching application of the smart device and the portable device.

In practice, when a user activates the smart device and the portable device at the same time, all the modules of the terminals are also activated. After the smart device is activated, the multiple program sources are decoded by the generation module 71 to output one or multiple sets of program information to generate the program source list. The assignment module 77 then assigns a particular set or particular sets of program information to the local second module 79 for display and output, and/or a particular set or particular sets of program information to be decoded by the program encoding module 78 and then transmitted to the portable device. When the program information is assigned to the local second display module 79 for display and output, the smart device accordingly completes the viewing of the program information of the smart device or the program information of multiple sets of program information.

When the smart device and the portable device need to perform multi-image switching, the assignment module 77 assigns a particular set or particular sets of program information to the program encoding module 78 for encoding, and the encoded program information is transmitted to the portable device. To transmit data between the smart device and the portable device, a handshake needs to be established between the two by the first handshake module 55 and the second handshake module 75.

After the connection between the portable device and the smart device is established, the portable device transmits the program source list fetching request message to the smart device via the second transmission module 54. The smart device receives the program source list fetching request message, and transmits the program source list generated by the generation module 71 to the portable device via the third transmission module 72. The third transmission module 72 may further initiatively transmit the program source list to the portable device. The program source list includes the program source list updated in real-time.

The portable device fetches the program source list from the smart device via the first fetching module 51, and transmits the watch request message to the smart device according to the user-selected program source from the program source list. The watch request message includes program source identification information.

Because the watch request message includes program source identification information, after the second reception module 73 of the smart device receives the watch request message transmitted by the portable device, the program encoding module 78 may encode the program information corresponding to the program source identification information that is in response to the watch request message, and transmit the encoded program information to the portable device via the fourth transmission module 74.

The first reception module 53 of the portable device receives the program information, which is corresponding to the program source identification information and replied by the smart device in response to the watch request message. The program decoding module 57 decodes the program information, and the first display module 59 displays the decoded program information to the user.

In the smart device, media file information stored at the portable device or media streams collected in real-time from a media source may be encoded. The encoded information is then transmitted to the smart device for publishing and application, and displayed and outputted via the second display module 79; thereby expansion of multitasking and multi-application in household digital media life can be realized using a single smart device.

With the above descriptions, it is demonstrated that, in addition to viewing the same or different program information on the smart device and the portable device according to the method and system of the embodiments, program source switching may also be independently performed at the same time. Furthermore, with the method and system of the embodiments, media file information stored at the portable device or media streams collected in real-time may also be displayed and outputted by the smart device or outputted via an access channel, thereby implementing multitasking and multi-applications of a single smart device while offering enriched applications as well as more convenient and resource-economized operations of the smart device.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A multi-image switching method, comprising:
establishing a connection between a portable device and a smart device, and fetching a program source list from the smart device;
transmitting a watch request message to the smart device according to a user-selected program source from the program source list, wherein the watch request message comprises a program source identification information; and
receiving a program information corresponding to the program source identification information, wherein the program information is replied by the smart device in response to the watch request message, and providing the program information to the portable device.

2. The multi-image switching method according to claim 1, further comprising:
transmitting a fetch request message for fetching the program source list from the smart device after establishing the connection between the portable device and the smart device.

3. The multi-image switching method according to claim 1, wherein the step of establishing the connection between the portable device and the smart device comprises:
the portable device transmitting a handshake request message by broadcasting;
monitoring a broadcasting port to receive a handshake acknowledgement message replied by the smart device; and
transmitting a handshake success message to the smart device.

4. A multi-image switching method for a smart device, comprising:
receiving and decoding a plurality of program sources to generate at least one set of program information and a program source list;
establishing a connection with a portable device, and transmitting the program source list to the portable device;
receiving a watch request message transmitted by the portable device, wherein the watch request message comprises program source identification information; and
fetching program information corresponding to the program source identification information, and transmitting the program information to the portable device for display.

5. The multi-image switching method according to claim 4, further comprising:
transmitting a fetch request message for fetching the program source list from the smart device after establishing the connection between the portable device and the smart device.

6. A multi-image switching system, comprising:
a smart device, for decoding a plurality of received program sources to output at least one set of program information, and generating and transmitting a program source list accordingly; and
a portable device, signally connected to the smart device, for receiving and fetching the program source list from the smart device;
wherein the portable device transmits a watch request message comprising a program source identification information according to a user-selected program source from the program source list;
wherein the smart device transmits a program information corresponding to the program source identification information to the portable device after receiving the watch request message; and
wherein the portable device receives and displays the program information.

7. The multi-image switching system according to claim 6, comprising at least one portable device.

8. The multi-image switching system according to claim 6, wherein the portable device comprises:
a first fetching module, for fetching the program source list from the smart device;
a first transmission module, for transmitting the watch request message to the smart device according to the user-selected program source from the program source list; and
a first reception module, for receiving the program information corresponding to the program source identification information, wherein the program information is replied by the smart device in response to the watch request message, and displaying the program information.

9. The multi-image switching system according to claim 8, wherein the portable device further comprises:
a second transmission module, for transmitting a request message for fetching the program source list from the smart device.

10. The multi-image switching system according to claim 8, wherein the portable device further comprises:
a first handshake module, for establishing a connection between the portable device and the smart device, comprising:
a first transmission unit, for transmitting a handshake request message;
a reception unit, for monitoring a broadcasting port and receiving a handshake acknowledgement message replied by the smart device accordingly; and
a second transmission unit, for transmitting a handshake success message to the smart device after the reception unit receives the handshake acknowledgment message replied by the smart device.

11. The multi-image switching system according to claim 6, wherein the smart device comprises a multi-image switching unit, and the multi-image switching unit comprises:
a generation module, for decoding a plurality of program sources to output at least one set of program information and generate the program source list;
a third transmission module, for transmitting the program source list to the portable device after establishing the connection with the portable device;
a second reception module, for receiving the watch request message; and
a fourth transmission module, for transmitting the program information corresponding to the program source identification information to the portable device.

12. The multi-image switching system according to claim 11, wherein the third transmission module initiatively transmits the program source list to the portable device, and the program source list is updated in real-time.

13. The multi-image switching system according to claim 6, wherein the smart device comprises a multi-image switching unit, and the multi-image switching unit comprises:
a third reception module for receiving an information publish request message from the portable device after the connection is established with the portable device;
a fifth transmission module for transmitting an information publish permission message to the portable device;
a fourth reception module for receiving an information from the portable device via a transmission channel; and
a third display module for displaying and outputting the information received from the portable device.
